(19) United States
(12) Patent Application Publication
(10) Pub. No.: US 2019/0137319 A1
(43) Pub. Date: May 9, 2019

(54) FUEL LEVEL DETECTION DEVICE AND PRODUCTION METHOD THEREFOR

(71) Applicant: AISAN KOGYO KABUSHIKI KAISHA, Obu-shi, Aichi (JP)

(72) Inventors: Yuichi MANABE, Obu-shi, Aichi (JP); Nobuo SUZUKI, s (JP)

(21) Appl. No.: 16/309,705

(22) PCT Filed: Mar. 15, 2017
(86) PCT No.: PCT/JP2017/010478

§ 371 Date: Dec. 13, 2018

(30) Foreign Application Priority Data
Jun. 14, 2016 (JP) 2016-118016

(51) Int. Cl. G01F 23/36

(52) U.S. Cl. CPC G01F 23/363

(57) ABSTRACT

The liquid fuel level sensing device disclosed herein may include a liquid fuel level sensor, a case, and an electric wire. The case may house the liquid fuel level sensor and include opposing surfaces opposing each other. The electric wire may include a core wire and an insulating film, and the electric wire may include an exposed portion in which the core wire is exposed and a coated portion in which the core wire is coated with the insulating film. The exposed portion may be connected to a terminal of the liquid fuel level sensor, and the coated portion may be interposed between the opposing surfaces in a compressed state.

### TECHNICAL FIELD

The technique disclosed in the description herein relates to a liquid fuel level sensing device provided in a fuel tank and configured to sense a level of liquid fuel in the fuel tank.

### BACKGROUND ART

Japanese Patent Application Publication No. 2008-292420 describes a liquid fuel level sensing device provided with a liquid fuel level sensor (a Hall element), a case housing the liquid fuel level sensor, and electric wire connected to a terminal of the liquid fuel level sensor. The liquid fuel level sensing device is further provided with a float configured to float on fuel and an arm configured to convert up-and-down motion of the float to rotary motion. The float moves up and down as a level of the liquid fuel changes, by which the arm rotates. The liquid fuel level sensor outputs a signal according to an angle of the arm to the terminal. Thus, the signal outputted to the terminal indicates the level of the liquid fuel. The electric wire is provided with an exposed portion in which a core wire of the electric wire is exposed and a coated portion in which the core wire is coated with an insulating film. The exposed portion of the electric wire is connected to the terminal of the liquid fuel level sensor. The signal outputted to the terminal of the liquid fuel level sensor is transmitted externally through the electric wire. Further, a part of the terminal of the liquid fuel level sensor holds the coated portion of the electric wire by swaging or the like.

### SUMMARY OF INVENTION

### Technical Problem

A liquid fuel sensing device is provided in a fuel tank. As a vehicle moves, waves are caused in fuel in the fuel tank. Due to these waves, tensile force is repeatedly applied to an electric wire of the liquid fuel sensing device. Further, the fuel tank may expand thermally due to temperature change in some cases. Due to the thermal expansion of the fuel tank as well, tensile force is repeatedly applied to the electric wire of the liquid fuel sensing device. Due to the tensile force repeatedly applied to the electric wire, stress is repeatedly applied to a contact point between the exposed portion of the electric wire and the terminal of the liquid fuel level sensor. Due to the stress repeatedly applied to the contact point, the contact point may be deteriorated.

The liquid fuel sensing device of Japanese Patent Application Publication No. 2008-292420 suppresses stress applied to a contact point between the terminal of the liquid fuel level sensor and the exposed portion of the electric wire by a portion of the terminal of the liquid fuel level sensor holding the coated portion of the electric wire. However, since both of the exposed portion and the coated portion of the electric wire are connected to the terminal of the liquid fuel level sensor as above, stress concentrates in the terminal, as a result of which it is difficult to sufficiently reduce the stress to the contact point.

### Solution to Technical Problem

A liquid fuel level sensing device disclosed in the description herein may be provided in a fuel tank and configured to sense a level of liquid fuel in the fuel tank. This liquid fuel level sensing device may comprise a liquid fuel level sensor, a case, and an electric wire. The case may house the liquid fuel level sensor and comprise opposing surfaces opposing each other. The electric wire may comprise a core wire and an insulating film, and the electric wire may comprise an exposed portion in which the core wire is exposed and a coated portion in which the core wire is coated with the insulating film. The exposed portion may be connected to a terminal of the liquid fuel level sensor, and the coated portion may be interposed between the opposing surfaces in a compressed state.

In this liquid fuel level sensing device, the coated portion of the electric wire is interposed between the opposing surfaces of the case. That is, the exposed portion is connected to the terminal, while the coated portion is connected to the case. Therefore, when tensile force is applied to the electric wire, stress is suppressed from concentrating in the terminal. When the tensile force is applied to the electric wire, stress is applied to an interposed part (a part interposed between the opposing surfaces of the case) of the coated portion of the electric wire, by which application of stress to a contact point between the exposed portion of the electric wire and the terminal of the liquid fuel level sensor is suppressed. Due to this, in this liquid fuel level sensing device, the contact point is less likely to be deteriorated when tensile force is applied to the electric wire.

The description herein further provides a method of manufacturing a liquid fuel level sensing device. This method is for manufacturing a liquid fuel level sensing device provided in a fuel tank and configured to sense a level of liquid fuel in the fuel tank. The method may comprise housing a liquid fuel level sensor in a case; press-fitting an electric wire between opposing surfaces included in the case, the electric wire comprising a core wire and an insulating film, the electric wire comprising an exposed portion in which the core wire is exposed and a coated portion in which the core wire is coated with the insulating film, and the coated portion is press-fitted between the opposing surfaces; and connecting the exposed portion to a terminal included in the liquid fuel level sensor.

The aforementioned processes may be performed in any order. According to the manufacturing method, the exposed portion of the electric wire can be interposed between the opposing surfaces of the case. Therefore, according to the manufacturing method, a liquid fuel level sensing device in which stress is less likely to be applied to a contact point between the electric wire and the terminal can be manufactured.

### BRIEF DESCRIPTION OF DRAWINGS

FIG. 1 shows a configuration of a fuel pump module according to an embodiment;

FIG. 2 shows a front view of a magnetic sensor unit according to the embodiment;

FIG. 3 shows an exploded perspective view of the magnetic sensor unit according to the embodiment;

FIG. 4 shows a cross sectional view of an Iv-Iv cross section in FIG. 2; and

FIG. 5 shows an example of a variant of notches 52a to 52c.

### DESCRIPTION OF EMBODIMENTS

An embodiment described below includes a feature 1 described below. It should be noted that the feature 1 is an independent technical element, and is useful solely or in combinations.
(Feature 1) In a liquid fuel level sensing device according to the embodiment, each of opposing surfaces of a case comprises a plurality of protrusions arranged with intervals in a direction along which an electric wire extends. According to this configuration, a coated portion of the electric wire is less likely to come out from the opposing surfaces when tensile force is applied to the electric wire.

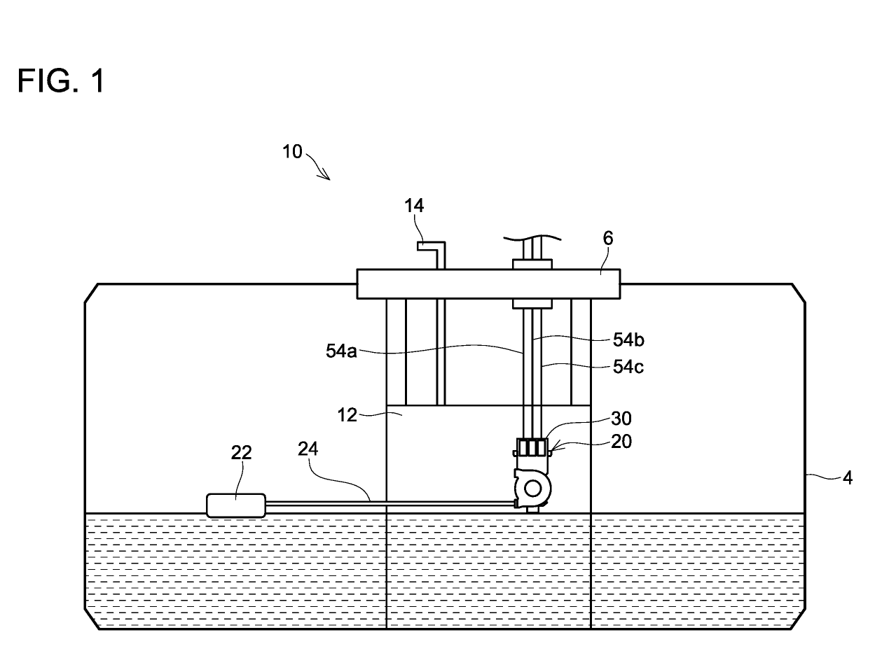

A fuel pump module 10 shown in FIG. 1 is a unit for supplying fuel in a fuel tank 4 of a vehicle, such as an automobile, to an engine which is not shown.

The fuel pump module 10 includes a fuel pump unit 12 and a liquid fuel level sensing device 20. The fuel pump unit 12 is housed in the fuel tank 4. The fuel pump unit 12 is attached to a set plate 6 that closes an opening of the fuel tank 4. The fuel pump unit 12 is configured to suction the fuel in the fuel tank 4 into the fuel pump unit 12, increase a pressure thereof, and discharge it to outside of the fuel pump unit 12. The fuel discharged from the fuel pump unit 12 is supplied to the engine, which is not shown, from a discharge port 14.

The liquid fuel level sensing device 20 includes a float 22, an arm 24, a magnetic sensor unit 30, and electric wires 54a to 54c. The float 22 floats on the fuel in the fuel tank 4 and moves in an up-down direction according to a liquid level of the fuel. The float 22 is rotatably attached to a distal end of the arm 24. A base end of the arm 24 is rotatably supported by the magnetic sensor unit 30. When the float 22 moves up and down according to the liquid level of the fuel in the fuel tank 4, the arm 24 pivotally rotates with respect to the fuel pump unit 12. That is, the arm 24 converts the up-and-down motion of the float 22 to rotary motion. The arm 24 is constituted of metal having tolerance against fuel, such as stainless, and has a cylindrical bar shape.

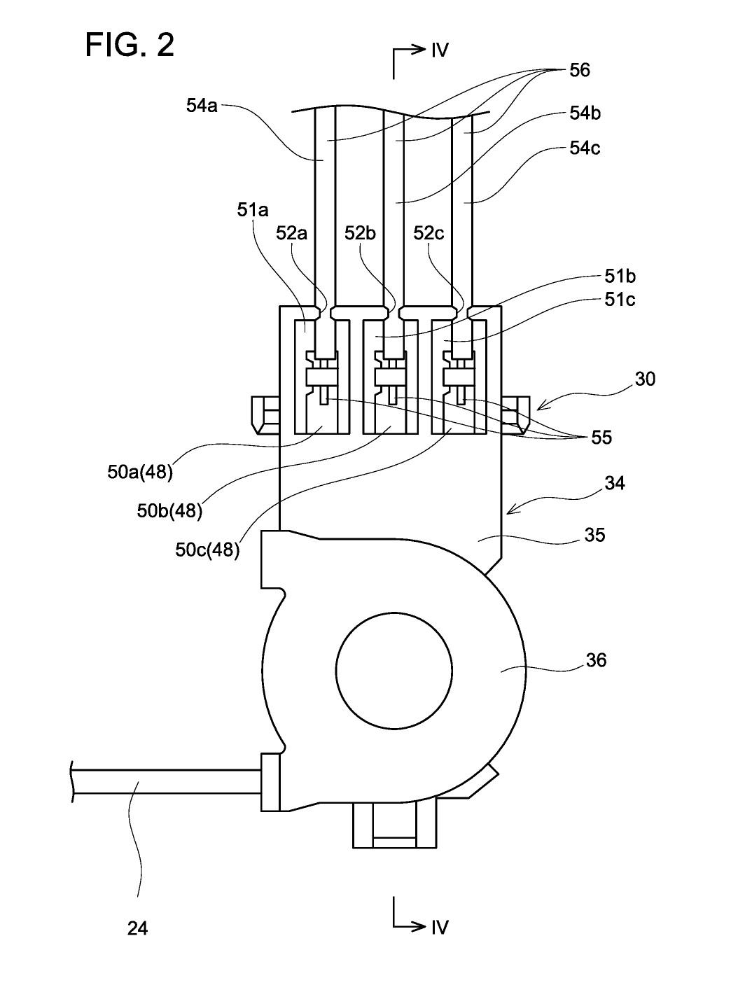

The magnetic sensor unit 30 rotatably supports the arm 24. The magnetic sensor unit 30 is configured to sense a rotation angle of the arm 24. As shown in FIGS. 2 to 4, the magnetic sensor unit 30 includes a case 34, a permanent magnet 44, a cover 36, and a liquid fuel level sensor 48. FIGS. 2 to 4 omit the float 22 and a part of the arm 24 on a float 22 side.

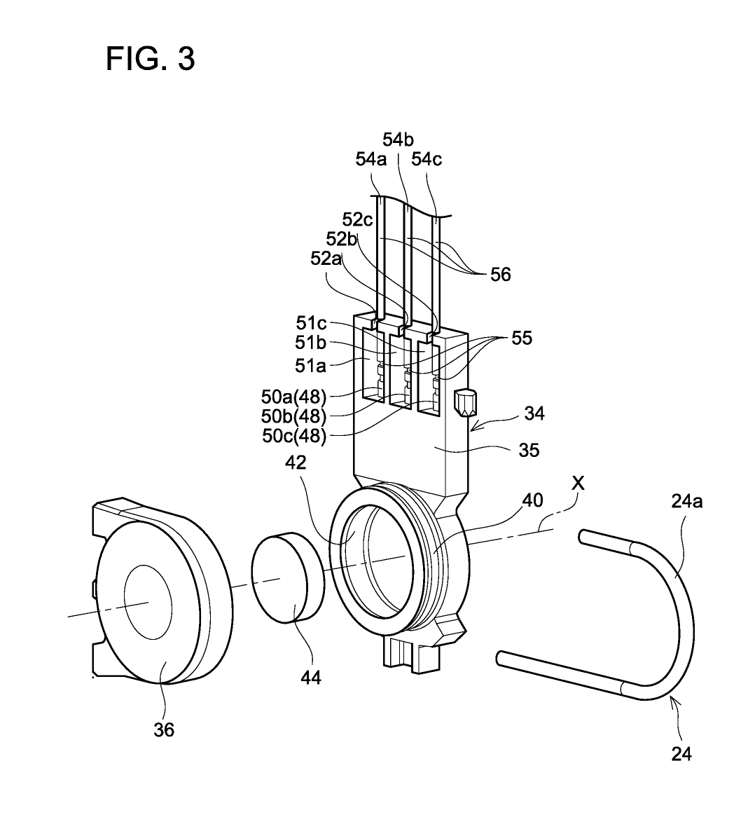

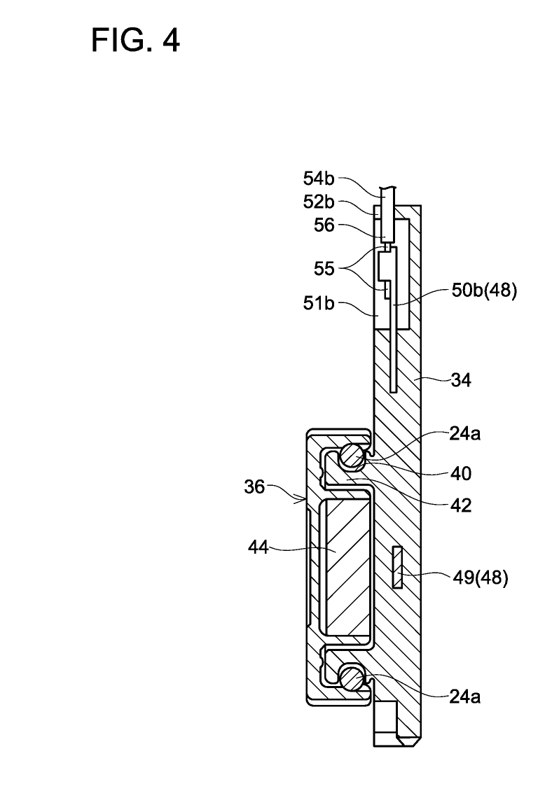

The case 34 is fixed to an outer wall of the fuel pump unit 12. The case 34 is constituted of resin. As shown in FIGS. 3 and 4, the case 34 includes a main body 35 and a cylinder portion 42. The main body 35 has a flat plate shape. A rear surface of the main body 35 is attached to the outer wall of the fuel pump unit 12. The cylinder portion 42 is disposed on a front surface side of the main body 35. The cylinder portion 42 protrudes from a front surface of the main body 35. The cylinder portion 42 has a cylindrical shape of which central axis is a rotary axis X of the arm 24. An outer circumferential surface of the cylinder portion 42 is provided with a groove 40.

The arm 24 includes a curved portion 24a which is curved in a semicircular shape at its end portion opposite to the float 22. The curved portion 24a of the arm 24 is inserted to the groove 40. The curved portion 24a slides along the groove 40. As such, the arm 24 is rotatably supported by the case 34. Further, the groove 40 prevents the arm 24 from being displaced in a direction parallel to the rotary axis X.

The cover 36 is attached to the arm 24. The cover 36 is rotatable about the rotary axis X with respect to the case 34. The cover 36 is fixed to the arm 24. Therefore, when the arm 24 rotates with respect to the case 34, the cover 36 rotates together with the arm 24.

As shown in FIG. 4, the permanent magnet 44 is fixed to a rear surface of the cover 36. Therefore, the permanent magnet 44 rotates about the rotary axis X together with the arm 24 and the cover 36. The permanent magnet 44 includes a south pole and a north pole which are polarized in a direction orthogonal to the rotary axis X.

The case 34 houses the liquid fuel level sensor 48. The liquid fuel level sensor 48 includes a semiconductor chip 49 and terminals 50a to 50c. The semiconductor chip 49 is disposed on the rotary axis X and is opposed to the permanent magnet 44. The terminals 50a to 50c are connected to the semiconductor chip 49 at positions inside the case 34, which are not shown. The semiconductor chip 49 is a so-called Hall element and is configured to sense a direction of magnetic field passing therethrough. Another magnetic sensing element, such as an MRE (Magnet Resistive Element), may be used instead of the semiconductor chip 49. The terminals 50a, 50c are terminals for supplying power to the semiconductor chip 49, and the terminal 50b is a signal output terminal of the semiconductor chip 49. The semiconductor chip 49 outputs to the terminal 50b a signal indicating a direction of magnetic field passing therethrough. The liquid fuel level sensor 48 (that is, the semiconductor chip 49 and the terminals 50a to 50c) is embedded in the case 34 when the case 34 is formed by injection molding. The liquid fuel level sensor 48 is covered by the case 34 (that is, by resin) except for ends of the terminals 50a to 50c. When the permanent magnet 44 rotates about the rotary axis X, the direction of magnetic field passing the semiconductor chip 49 changes. As such, the signal outputted by the semiconductor chip 49 to the terminal 50b changes according to a rotation angle of the permanent magnet 44. The rotation angle of the permanent magnet 44 represents the rotation angle of the arm 24. Further, the rotation angle of the arm 24 corresponds to a position of the float 22 in the up-down direction (that is, the liquid level of the fuel). Therefore, the signal outputted by the semiconductor chip 49 to the terminal 50b represents the liquid level of the fuel.

As shown in FIG. 2, the case 34 is provided with three spaces (recesses) 51a to 51c. The end of the terminal 50a is exposed inside the space 51a, the end of the terminal 50b is exposed inside the space 51b, and the end of the terminal 50c is exposed inside the space 51c. Upper partition walls of the spaces 51a to 51c are provided with notches 52a to 52c, respectively. The notch 52a is provided in an upper portion of the space 51a, the notch 52b is provided in an upper portion of the space 51b, and the notch 52c is provided in an upper portion of the space 51c. Each of the notches 52a to 52c includes a pair of opposing surfaces which oppose to each other.

As shown in FIG. 1, the three strands of electric wires 54a to 54c are connected to the magnetic sensor unit 30. One end (a lower end) of each of the electric wires 54a to 54c is connected to the magnetic sensor unit 30. Each of the electric wires 54a to 54c extends upward from the magnetic sensor unit 30, penetrates the set plate 6, and is pulled out externally. Another end of each of the electric wires 54a to 54c is connected to a fuel meter, which is not shown. Each of the electric wires 54a to 54c includes a core wire and an insulating film. As shown in FIGS. 2 to 4, at the lower ends of the electric wires 54a to 54c, their core wires are exposed without being coated by the insulating films. Hereinbelow, the portion of the electric wire in which the core wire is exposed will be termed an exposed portion 55. In portions of the electric wires 54a to 54c, excluding their lower ends, the core wires are coated by the insulating films. Hereinbelow, the portion of the electric wire in which the core wire is coated by the insulating film will be termed a coated portion 56.

The electric wire 54a extends to inside of the space 51a through the notch 52a. In the space 51a, the exposed portion 55 (that is, the core wire) of the electric wire 54a is connected to the terminal 50a. More specifically, the exposed portion 55 is swaged by the terminal 50a and the exposed portion 55 is thereby fixed to the terminal 50a. The exposed portion 55 is electrically connected to the terminal 50a. A width of the notch 52a is narrower than a diameter of the coated portion 56 of the electric wire 54a (more specifically, the diameter of the coated portion 56 in an uncompressed state). Due to this, the coated portion 56 of the electric wire 54a is interposed between the opposing surfaces of the notch 52a in a compressed state. As such, the coated portion 56 is fixed by the notch 52a. As shown in FIG. 2, the coated portion 56 is compressed at the notch 52a, and a width of the coated portion 56 at the notch 52a is narrower than the width of the coated portion 56 at another position. Due to this, when tensile force is applied to the electric wire 54a, stress is applied to the coated portion 56 held by the notch 52a and the application of the stress is suppressed to a contact point between the electric wire 54a and the terminal 50a.

The electric wire 54b is connected to the terminal 50b inside the space 51b. A connection configuration of the electric wire 54b is substantially identical to the connection configuration of the electric wire 54a. That is, the exposed portion 55 (the lower end) of the electric wire 54b is fixed to the terminal 50b by being swaged. The coated portion 56 of the electric wire 54b is interposed between the opposing surfaces of the notch 52b in the compressed state.

The electric wire 54c is connected to the terminal 50c inside the space 51c. A connection configuration of the electric wire 54c is substantially identical to the connection configuration of the electric wire 54a. That is, the exposed portion 55 (the lower end) of the electric wire 54c is fixed to the terminal 50c by being swaged. The coated portion 56 of the electric wire 54c is interposed between the opposing surfaces of the notch 52c in the compressed state.

When a liquid surface of the fuel in the fuel tank 4 is located above the magnetic sensor unit 30 and waves are caused in the liquid surface of the fuel, the waves hit the electric wires 54a to 54c. When this happens, tensile force is applied to the electric wires 54a to 54c. Further, when the fuel tank 4 thermally expands, an interval between upper and lower surfaces of the fuel tank 4 is widened, by which tensile force is applied to the electric wires 54a to 54c. When the tensile force is applied to the electric wires 54a to 54c as above, stress is applied to lower portions of the electric wires 54a to 54c in a direction pulling the electric wires 54a to 54c upward. In the liquid fuel level sensing device 20 of the present embodiment, the coated portion 56 of the electric wire 54a is interposed between the opposing surfaces of the notch 52a of the case 34 in the compressed state. Due to this, the coated portion 56 of the electric wire 54a is fixed to the case 34. Therefore, when the electric wire 54a is pulled upward, stress is applied to the notch 52a and the coated portion 56 held by the notch 52a. Due to this, application of the stress is suppressed to a portion of the electric wire 54a below the notch 52a. That is, application of the stress is suppressed to the contact point (swaged portion) between the exposed portion 55 of the electric wire 54a and the terminal 50a. As such, a poor connection is less likely to occur at the contact point. Especially by the configuration in which the coated portion 56 is fixed to the case 34, a distance from a fixed portion of the coated portion 56 to the case 34 (that is, the portion held by the notch 52a) to the contact point (the contact point between the exposed portion 55 and the terminal 50a) can be increased. Due to this, stress is far less likely to be applied to the contact point. Therefore, according to the liquid fuel level sensing device 20, deterioration of the contact point can be further suppressed. Further, the electric wires 54b, 54c include the identical connection configuration to the above one. Therefore, stress is less likely to be applied to contact points between the electric wire 54b and the terminal 50b and between the electric wire 54c and the terminal 50c as well, deterioration of these contact points can be suppressed.

Further, since stress is less likely to be applied to the contact points between the exposed portions 55 of the electric wires 54a to 54c and the terminals 50a to 50c, deterioration of these contact points can be suppressed even when the exposed portions 55 are fixed to the terminals 50a to 50c only by being swaged. Since there is no need to perform welding or the like on these contact points, the liquid fuel level sensing device 20 can be manufactured more efficiently. However, if a higher strength is desired for these contact points, the contact points may be connected by welding or the like.

Next, a method of manufacturing the liquid fuel level sensing device 20 will be described. The manufacturing method of the present embodiment includes features as to a connecting processes for the electric wires 54a to 54c, the terminals 50a to 50c, and the case 34, and thus, these connecting processes will be mainly described hereinbelow.

Firstly, the case 34 is formed by injection molding. At a completion of the injection molding, the semiconductor chip 49 and the terminals 50a to 50c are housed inside the case 34. Further, at the completion of the injection molding, the case 34 includes the notches 52a to 52c. After the injection molding, a characteristic inspection for the semiconductor chip 49 is performed via the terminals 50a to 50c.

Next, the electric wires 54a to 54c respectively provided with the exposed portions 55 in their end portions are prepared, and the coated portions 56 of the electric wires 54a to 54c are press-fitted to the notches 52a to 52c, respectively. Due to this, the coated portions 56 of the electric wires 54a to 54c are interposed between the opposing surfaces of the corresponding notches 52a to 52c in the compressed state. As such, the coated portions 56 of the electric wires 54a to 54c are fixed to the case 34. At a completion of the press-fit process, the exposed portions 55 of the electric wires 54a to 54c are in contact with the terminals 50a to 50c, respectively.

Next, the terminals 50a to 50c are deformed by using a specialized tool to swage the exposed portions 55 of the electric wires 54a to 54c by the terminals 50a to 50c. Due to this, the terminals 50a to 50c are connected to the electric wires 54a to 54c.

According to the processes above, the electric wires 54a to 54c, the terminals 50a to 50c, and the case 34 are fixed to each other. After this, necessary members such as the arm 24, the float 22, and the permanent magnet 44 are attached, by which the liquid fuel level sensing device 20 is completed.

As a method of fixing the electric wires 54a to 54c to the case 34, a method is considered in which the electric wires 54a to 54c are connected to the terminals 50a to 50c in advance, the electric wires 54a to 54c are then set in a molding die together with the terminals 50a to 50c, and the case 34 is thereafter formed by injection molding. According to this method, the case 34 can be formed in a state where the case 34 is integrated with the electric wires 54a to 54c. However, this method has a problem that the process of setting the electric wires 54a to 54c in the molding die is not easy and thus manufacturing efficiency declines. Further, the characteristic inspection for the semiconductor chip 49 after the resin formation has to be performed in a state where the electric wires 54a to 54c are attached. The characteristic inspection takes a long time since the electric wires 54a to 54c hinder. Contrary to this, according to the manufacturing method of the present embodiment, the characteristic inspection can be performed after the resin forming in a state where the electric wires 54a to 54c are not connected. Due to this, the characteristic inspection can be easily performed. As above, according to the manufacturing method of the present embodiment, the liquid fuel level sensing device 20 can be manufactured efficiently.

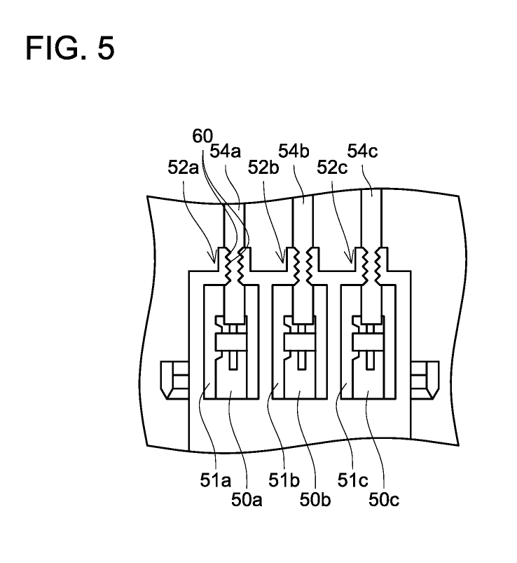

In the embodiment above, each of the opposing surfaces of notches 52a to 52c is substantially flat. Contrary to this, each of the opposing surfaces may include a plurality of protrusions 60, as shown in FIG. 5. In FIG. 5, on each of the opposing surfaces, the plurality of protrusions 60 is arranged with intervals therebetween in a direction along which the electric wires 54a to 54c extend. In this configuration, when tensile force is applied to the electric wires 54 to 54c, the electric wires 54a to 54c are less likely to be displaced with respect to the notches 52a to 52c, respectively. According to this configuration, the electric wires 54a to 54c can be more firmly fixed to the case 34. Due to this, stress is less likely to be applied to the contact points between the electric wires 54a to 54c and the terminals 50a to 50c, and thus deterioration of the contact points can be suppressed favorably.

While specific examples of the present invention have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present invention is not limited to the combinations described at the time the claims are filed. Further, the purpose of the examples illustrated by the present description or drawings is to satisfy multiple objectives simultaneously, and satisfying any one of those objectives gives technical utility to the present invention.

1. A liquid fuel level sensing device provided in a fuel tank and configured to sense a level of liquid fuel in the fuel tank, the liquid fuel level sensing device comprising:
a liquid fuel level sensor;
a case housing the liquid fuel level sensor and comprising opposing surfaces opposing each other, and
an electric wire comprising a core wire and an insulating film, the electric wire comprising an exposed portion in which the core wire is exposed and a coated portion in which the core wire is coated with the insulating film, the exposed portion being connected to a terminal of the liquid fuel level sensor, and the coated portion being interposed between the opposing surfaces in a compressed state.

2. The liquid fuel level sensing device of claim 1, wherein each of the opposing surfaces comprises a plurality of protrusions arranged with intervals in a direction along which the electric wire extends.

3. A method of manufacturing a liquid fuel level sensing device, the liquid fuel level sensing device provided in a fuel tank and configured to sense a level of liquid fuel in the fuel tank, the method comprising:
housing a liquid fuel level sensor in a case;
press-fitting an electric wire between opposing surfaces included in the case, the electric wire comprising a core wire and an insulating film, the electric wire comprising an exposed portion in which the core wire is exposed and a coated portion in which the core wire is coated with the insulating film, and the coated portion is press-fitted between the opposing surfaces; and
connecting the exposed portion to a terminal included in the liquid fuel level sensor.
